(19) United States
(12) Patent Application Publication
(10) Pub. No.: US 2013/0083353 A1
(43) Pub. Date: Apr. 4, 2013

(54) IMAGE FORMING SYSTEM, IMAGE FORMING APPARATUS, AND PROCESSING SERVER

(71) Applicants: Naoki NISHIKAWA, Nagoya-shi (JP); Toyoshi ADACHI, Iwakura-shi (JP)

(72) Inventors: Naoki NISHIKAWA, Nagoya-shi (JP); Toyoshi ADACHI, Iwakura-shi (JP)

(73) Assignee: BROTHER KOGYO KABUSHIKI KAISHA, Nagoya-shi (JP)

(21) Appl. No.: 13/427,326

(22) Filed: Mar. 22, 2012

(30) Foreign Application Priority Data
Sep. 30, 2011 (JP) 2011-216304

(51) Int. Cl. G06F 3/12

(52) U.S. Cl. 358/1.15

(57) ABSTRACT

An image forming system is provided including a data server, an image forming apparatus, and a processing server. The image forming apparatus includes an information acquisition section configured to acquire identification information, and a first transmission section configured to send the identification information to the processing server. The processing server includes a print data acquisition section configured to acquire an identified print data identified through the identification information, a processing treatment section configured to carry out the processing treatment for the identified print data, and a second transmission section configured to transmit a processed data processed by the processing treatment section to the image forming apparatus.

### CROSS REFERENCE TO RELATED APPLICATION

The present application claims priority from Japanese Patent Application No. 2011-216304, filed on Sep. 30, 2011, the disclosure of which is incorporated herein by reference in its entirety.

### BACKGROUND OF THE INVENTION

1. Field of the Invention

The present invention relates to an image forming apparatus carrying out printing for a print data, a processing server applying a processing treatment to the print data, and an image forming system including these devices.

2. Description of the Related Art

Conventionally, there have been image forming apparatuses known to request external devices to carry out processing treatments for print data such as data conversion processing, image processing and the like, and then receive the processed data for printing. For example, when an image forming apparatus without an interpreter for some high-level language has received a print data created with that high-level language, the image forming apparatus requests a server with an interpreter for the high-level language to convert image data, thereby realizing the printing for the image data.

In this manner, as a technique for transferring print data to an external device to let the external device carry out processing treatments instead of the image forming apparatus, for example, Japanese Patent Application Laid-Open No. 2006-227927 discloses a printing system including an RIP (Raster Image Processor) server as an external device of the image forming apparatus included in the same network with the RIP server. Whenever receiving an image data, the image forming apparatus requests the RIP server for raster image processing.

However, there is a problem as below in the conventional techniques described hereinabove. That is, a conventional system sends print data to the external device after the image forming apparatus receives the print data. Then, after the external device has processed the print data, the image forming apparatus receives the processed print data again, and starts printing for the print data. In such a manner, since the print data passes through a number of nodes, a certain amount of time is required from entering a print execution command to the beginning of printing. As a result, it takes time for a user to obtain the printed material.

### SUMMARY OF THE INVENTION

Accordingly, the present teaching is configured to solve the above problem in the conventional techniques. That is, an object of the present teaching is to provide an image forming system, an image forming apparatus and a processing server with a high possibility of obtaining the printed material in a short time when an external device carries out processing treatments for the print data.

According to a first aspect of the present teaching, there is provided image forming system which forms an image on a medium, the system including:

a data server which stores print data;

an image forming apparatus which carries out printing for the print data; and

a processing server which carries out a processing treatment for the print data,

wherein the image forming apparatus includes an information acquisition section which is configured to acquire identification information including information for identifying the print target, and a first transmission section which is configured to transmit the identification information to the processing server under a condition that the information acquisition section has acquired the identification information; and

the processing server includes a print data acquisition section which is configured to acquire an identified print data identified through the identification information among the print data stored in the data server in the case of receiving the identification information from the image forming apparatus, a processing treatment section which is configured to carry out the processing treatment for the identified print data acquired by the print data acquisition section, and a second transmission section which is configured to transmit, to the image forming apparatus, a processed data which is the identified print data that has been processed by the processing treatment section.

The image forming system of the present teaching causes the processing server to process the print data stored in the data server, and causes the image forming apparatus to print for the processed print data (the processed data). On acquiring identification information including information for identifying a print target (a print object), the image forming apparatus constituting the image forming system of the present teaching sends the identification information to the processing server. The image forming apparatus can identify a print data to become the print target by, for example, acquiring from the data server an inspection data of the print setting associated with the print data. Further, when the user information is acquirable, then it is possible to identify the print target as the print data of that user. On receiving the identification information from the image forming apparatus, the processing server acquires from the data server a print data identified through the identification information (the identified print data), carries out a processing treatment for the identified print data, and sends the processed data to the image forming apparatus.

That is, in the image forming system of the present teaching, the unprocessed print data directly moves to the processing server without passing through the image forming apparatus. Therefore, compared with systems as in the conventional techniques where the print data moves to the processing server through the image forming apparatus, the print data passes through fewer nodes. As a result, it is expectable for the image forming apparatus to start printing at an early stage. Further, the processing treatment carried out by the processing server corresponds to, for example, raster image processing, watermark processing, and translucent processing. Further, it may also be a process of converting a PDL data into another PDL data such as from PCL to PostScript, and the like.

According to a second aspect of the present teaching, there is provided an image forming apparatus which forms an image on a medium, the apparatus being connected through communication channels with a data server which stores print data, and a processing server which carries out a processing treatment for the print data, the apparatus including:

an information acquisition section configured to acquire identification information including information for identifying a print target;

an acquisition instruction section configured to transmit the identification information to the processing server under a condition that the information acquisition section has acquired the identification information, and the acquisition instruction section is configured to cause the processing server to acquire an identified print data which is the print data identified through the identification information among the print data stored in the data server; and

a printing section configured to receive a processed data which is the identified print data to which the processing treatment has been applied by the processing server, and to carry out printing for the processed data.

According to a third aspect of the present teaching, there is provided a processing server which processes print data, the server being connected through communication channels with a data server for storing the print data, and an image forming apparatus which carries out printing for the print data on a medium, the server including:

a receiving section which receives identification information including information for identifying a print target from the image forming apparatus;

a print data acquisition section configured to acquire an identified print data which is the print data identified through the identification information among the print data stored in the data server under a condition that the receiving section has received the identification information;

a processing treatment section configured to carry out a processing treatment for the identified print data acquired by the print data acquisition section; and a transmission section configured to transmit, to the image forming apparatus, a processed data which is the identified print data that has been processed by the processing treatment section.

### BRIEF DESCRIPTION OF THE DRAWINGS

FIG. 1 is a block diagram showing an electrical configuration of a printer and a processing server in accordance with a first embodiment of the present invention;

FIG. 2 is a timing chart showing a timing of data transmission between the printer and a cloud server in accordance with the first embodiment;

FIG. 3 shows a configuration of an inspection data;

FIG. 4 is a flowchart showing an operational procedure of the cloud server in accordance with the first embodiment;

FIG. 5 is a flowchart showing an operational procedure of the printer in accordance with the first embodiment;

FIG. 6 is a flowchart showing an operational procedure of the processing server in accordance with the first embodiment;

FIG. 7 is a timing chart showing a timing of data transmission between a printer, a cloud server, and a processing server in accordance with a second embodiment of the present invention;

FIGS. 8A and 8B are flowcharts showing an operational procedure of the cloud server in accordance with the second embodiment;

FIGS. 9A and 9B are flowcharts showing an operational procedure of the printer in accordance with the second embodiment;

FIGS. 10A and 10B are flowcharts showing an operational procedure of the processing server in accordance with the second embodiment; and

FIGS. 11A and 11B are flowcharts showing an operational procedure of the processing server in accordance with an application example of the second embodiment.

### DESCRIPTION OF THE PREFERRED EMBODIMENTS

Hereinbelow, referring to the accompanying drawings, explanations will be made in detail with respect to preferred embodiments in which an image forming apparatus in accordance with the present teaching is exemplified. In the embodiments, the present teaching is applied to a cloud server for storing print data, a printer without an interpreter function for high-level language, a processing server with an interpreter function for high-level language, and an image forming system including the above devices. The high-level language is a generic term for the programming languages to be converted into machine languages by a compiler or an interpreter and then to be executed. A cloud server refers to a virtual server which is located beyond a cloud in the concept of cloud computing to pass packets through the cloud, and can be manipulated with a Web browser.

<Configuration of the printer>

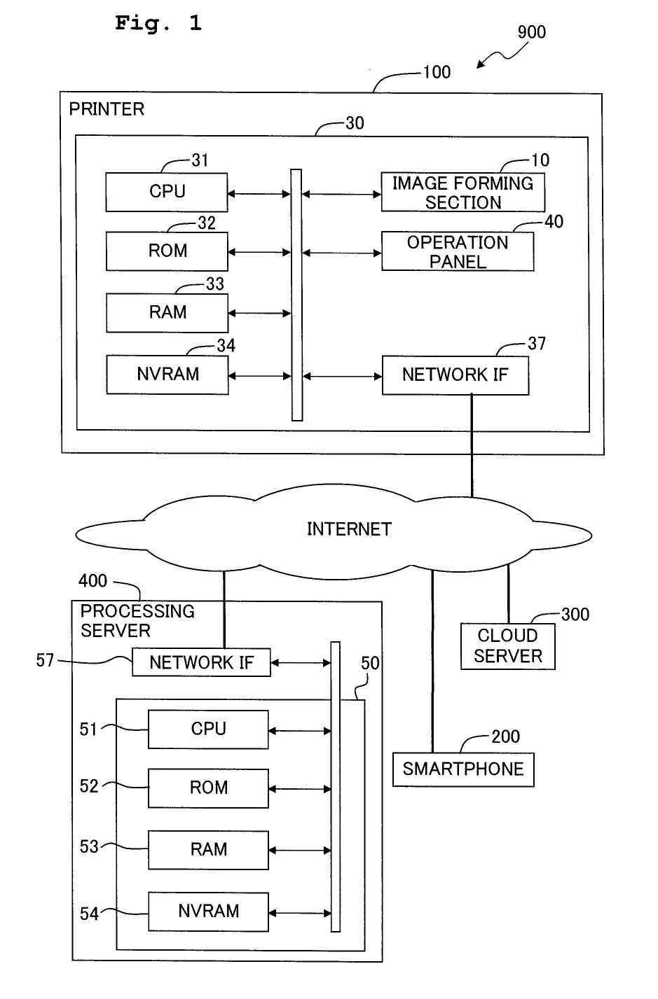

As shown in FIG. 1, a printer 100 of this embodiment (an example of the image forming apparatus) is provided with a controller 30 including a CPU 31, a ROM 32, a RAM 33, and an NVRAM 34 (Non Volatile RAM). Further, the controller 30 is communicatably connected with an image forming section 10 for printing images on printing paper, an operation panel 40 for displaying operating conditions and accepting user's input manipulations, and a network interface 37.

The ROM 32 stores firmware which is control programs for controlling the printer 100, and a variety of setting and initial values. The RAM 33 and NVRAM 34 are utilized as working areas for reading out the various control programs, or as storage areas for temporarily storing print data.

The CPU 31 (an example of the information acquisition section, first transmission section, second information acquisition section, and third transmission section) controls each component of the printer 100 while storing the processing result into the RAM 33 or the NVRAM 34 according to the control programs read out from the ROM 32 and the signals sent from various sensors.

The network interface 37 is an interface enabling the printer 100 to communicate with other devices. The printer 100 receives print data sent from other devices through the network interface 37.

Further, the image forming section 10 (an example of the printing section) may adopt either an electrophotographic method or an ink jet method as the image forming method as long as it is capable of printing images on printing paper. Further, the image forming section 10 may either be capable of color print or be dedicated to black-and-white print. In this embodiment, the image forming section 10 uses the electrophotographic method, and is capable of color print.

Further, the operation panel 40 has various buttons for accepting user's inputs, and a touch screen for displaying character information, buttons, and the like. As the various buttons, for example, there are an OK button for instruction to start a printing operation, and a cancel button for instruction to cancel a printing operation. Note that, the above configuration of the operation panel 40 is merely an example, and the present teaching is not limited to such configuration.

<Configuration of the processing server>

As shown in FIG. 1, a processing server 400 of the embodiment (an example of the processing server) is provided with a controller 50 including a CPU 51, a ROM 52, a RAM 53, an NVRAM 54 (Non Volatile RAM). Further, the controller 50 is communicatably connected with a network interface 57.

The ROM 52 stores various processing programs for applying processing treatments to print data, and a variety of setting and initial values. The RAM 53 and NVRAM 54 are utilized as working areas for reading out the various processing programs, or as storage areas for temporarily storing print data.

The CPU 51 (an example of the print data acquisition section, processing treatment section, second transmission section, second print data acquisition section, second processing treatment section, and determination section) carries out a processing treatment for print data while storing the processing result into the RAM 53 or the NVRAM 54 according to the processing programs read out from the ROM 52.

The network interface 57 is an interface enabling the processing server 400 to communicate with other devices. The processing server 400 receives print data sent from other devices through the network interface 57.

<Configuration of the image forming system>

Next, explanations will be made with respect to an image forming system 900 having the printer 100, a cloud server 300, and the processing server 400. The image forming system 900 has the printer 100, a smartphone 200, the cloud server 300 and the processing server 400 which are connected on the Internet (see FIG. 1). The smartphone is a cellular phone embracing the function of a portable PC.

The printer 100 carries out printing for print data. The printer 100 has a raster image processing function (RIP function) for page-description language data (PDL data) such as PCL, PostScript and the like, but does not have an RIP function for other high-level languages. Further, the printer 100 stores login information for each user to utilize the cloud server 300. For example, a user is to input login information including the ID and password in advance from the operation panel 40, and store the same into the RAM 33 or the NVRAM 34.

The smartphone 200 is an example of an information processing device for storing print data and inputting a print instruction for the print data to the cloud server 300. The cloud server 300 stores print jobs outputted from information processing devices such as the smartphone 200 and the like, and sends the stored print jobs to image forming apparatuses such as the printer 100 and the like. Further, the cloud server 300 also accepts print data from other information processing devices besides the smartphone 200, and a plurality of print data are uploaded in the cloud server 300. Further, the cloud server 300 is also capable of sending print data to other apparatuses besides the printer 100.

The processing server 400 is a device for carrying out, instead of the printer 100, processing treatments not performable by the printer 100. For example, in the image forming system 900, instead of the printer 100, the processing server 400 carries out the raster image processing for print data not performable by the printer 100.

In the image forming system 900, the smartphone 200 and the like previously send and store the print data into the cloud server 300. In order to carry out printing for the print data stored in the cloud server 300, the user operates the smartphone 200 or the printer 100 to login to the cloud server 300, selects the print data for printing, and inputs a print instruction. Further, in the case of inputting the print instruction from the smartphone 200, the user also selects the printer for carrying out the printing (in the preferred embodiments, explanations are made supposing the printer 100 is selected). When the print instruction is inputted, the printer 100 carries out printing for the selected print data.

### FIRST EMBODIMENT

<Operational procedure of the image forming system>

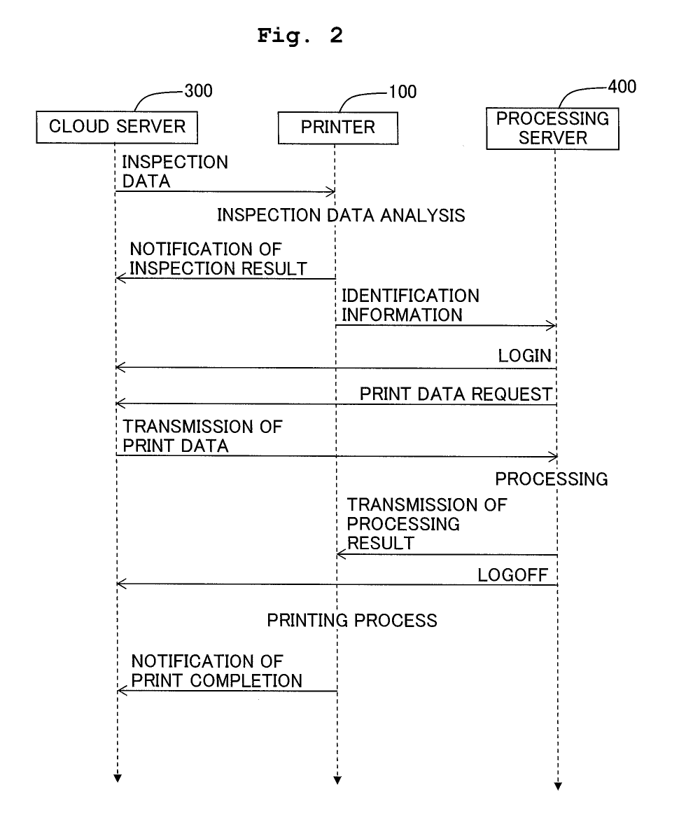

Next, referring to the timing chart of FIG. 2, explanations will be made with respect to a specific operational procedure of the image forming system 900. In the following explanations, print data are supposed to be stored in the cloud server 300. Further, as a premise for the cloud server 300 to accept instructions from a user, the user is considered as having logged into the cloud server 300. Further, although instructions to the cloud server 300 are in practice issued by devices having logged into the cloud server 300 (for example, the smartphone 200 or the printer 100), the following explanations will omit the data transmissions between the logged-in devices and the cloud server 300.

In the image forming system 900 of the first embodiment, first, the user selects a printer for carrying out printing. In the case of login from printers, the selection of a printer may as well be omitted. Next, the user selects the print data for printing from those registered in the cloud server 300. Then, the user carries out a print setting. After the print setting is finished, a print execution command according to the print setting is inputted to the cloud server 300.

On accepting the print execution command, the cloud server 300 sends an inspection request according to the print setting to the selected printer (the printer 100 in the first embodiment) before sending the print data.

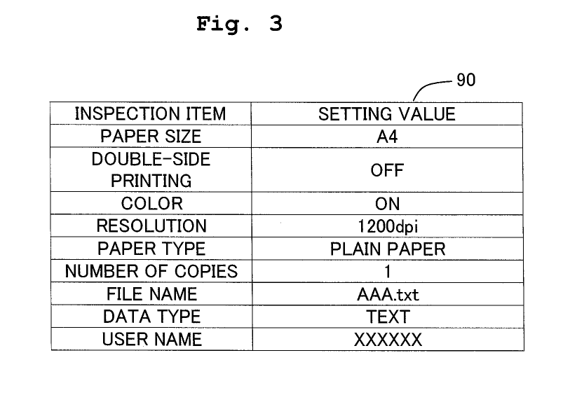

As shown in FIG. 3, an inspection data 90 is added to the inspection request, including a print setting such as the size of printing paper and the like. The inspection data 90 records the contents of print setting (including at least the size of printing paper, double-side print setting, color setting, resolution, the type of printing paper, and the number of print copies in the first embodiment), the file name of print data, the type of print data, and the user name. Note that, the data structure shown in FIG. 3 is an example of listing the typical items of print setting, and thus should not be limited thereto. For example, the inspection data 90 may as well record a more detailed print setting. Alternatively, it may as well be composed of fewer items than those shown in FIG. 3. The inspection data 90 includes the print setting for a print job but does not include the print data per se. Further, the inspection request of the first embodiment is configured to conform to IPP 2.0 which is the protocol of cloud print.

On receiving the inspection request, the printer 100 analyzes whether or not it is possible to print for each item of the print setting of the inspection data 90 added to the inspection request. This analysis takes into consideration not only the specification of the printer itself but also its status (the state of shortage of toner, paper out and the like). Therefore, even though it is possible to print by considering only the specification of the printer, when the printer is in a state unable to carry out printing, then the printer 100 determines that printing is not possible. For example, even when the printer is capable of color print but is detected to be short of the toner of a certain color, then it is not possible to carry out color print. In this manner, even when color print is possible according to the specification of the printer, it may still be impossible according to the status of the printer. In such cases, the printer 100 determines that printing is not possible. Further, when the printer 100 has been set to forbid printing by a specific user, then it determines that printing is not possible for the inspection request from that specific user. Then, the printer 100 sends the analysis result to the cloud server 300 as a notification of inspection result.

Further, on receiving an inspection request, the printer 100 identifies the user and the print data from the information recorded in the inspection data 90, and the login information acquired by starting the session with the cloud server 300. Then, it sends the identification information for identifying the user and the print data to the processing server 400.

On receiving the identification information from the printer 100, the processing server 400 logs into the cloud server 300 on behalf of the user (the identified user) identified by the identification information. Then, the processing server 400 sends a print data request to the cloud server 300 for requesting to send the print data (the identified print data) identified by the identification information. After receiving the print data request, the cloud server 300 sends the identified print data to the processing server 400.

After receiving the identified print data, the processing server 400 carries out a processing treatment for the identified print data as necessary, and sends the identified print data after the treatment (the processed data) to the printer 100. The processing server 400 logs off the cloud server 300 after sending the print data to the printer 100.

On the other hand, the printer 100 receives the processed data from the processing server 400, and carries out printing for the processed data. After the printing is completed, the printer 100 sends a print completion notification to the cloud server 300. Further, in case some error has arisen in the printing, the printer 100 sends an error notification to the cloud server 300.

<Control of the cloud server>

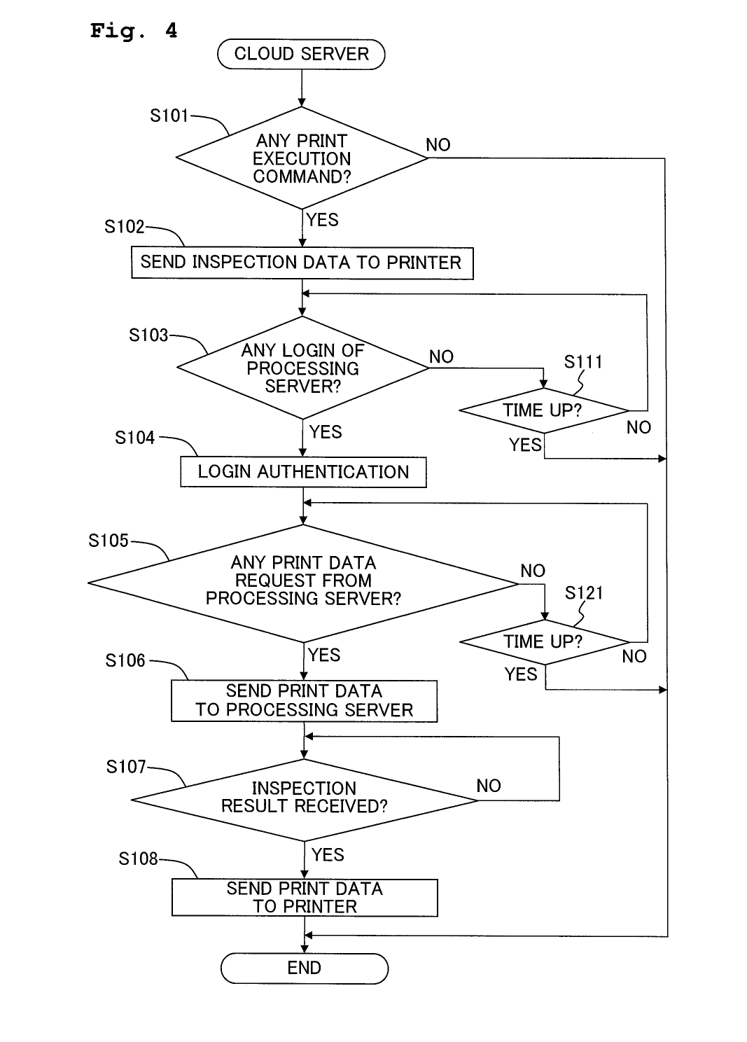

Next, explanations will be made with respect to the operational procedure of each device for realizing a printing operation of the image forming system 900 of the first embodiment. At first, referring to the flowchart of FIG. 4, the operation of the cloud server 300 will be explained. Further, the cloud server 300 periodically (every one second, for example) carries out the process shown in the flowchart of FIG. 4.

The cloud server 300 first determines whether or not the print execution command is accepted (S101) for the print data registered in the cloud server 300. When the print execution command is not accepted (S101: No), then the cloud server 300 ends the present process.

When the print execution command is accepted (S101: Yes), then the cloud server 300 generates the inspection data 90 according to the print setting of the print execution command, and sends the inspection data 90 to the printer 100 (S102). Thereafter, the cloud server 300 determines whether or not the processing server 400 has logged in (S103). When no login is determined (S103: No), then the cloud server 300 determines whether or not a predetermined or longer period of time has elapsed since the inspection data 90 was sent, that is, whether or not the time is up (S111). When the time is not up (S111: No), then the cloud server 300 returns the process to the step 5103 to determine again whether or not the processing server 400 has logged in, and waits for the processing server 400 to log in until the time is up. When the time is up (S111: Yes), then the cloud server 300 ends the present process.

When the processing server 400 has logged in (S103: Yes), then the cloud server 300 carries out an authentication process for the login (S104), and then determines whether or not a print data request is received from the processing server 400 (S105). When there is no print data request (S105: No), then the cloud server 300 determines whether or not a predetermined or longer period of time has elapsed since the processing server 400 logged in, that is, whether or not the time is up (S121). When the time is not up (S121: No), then the cloud server 300 returns the process to the step S105 to determine again whether or not a print data request is received from the processing server 400, and waits for a print data request from the processing server 400 until the time is up. When the time is up (S121: Yes), then the cloud server 300 ends the present process.

When there is a print data request from the processing server 400 (S 105: Yes), then the cloud server 300 sends the print data requested for download to the processing server 400 (S106). Thereafter, the cloud server 300 determines whether or not an inspection result is received (S107) for the inspection data 90 sent in the aforementioned process (S102). When the inspection result is not received (S107: No), then the cloud server 300 waits to receive the inspection result. When the inspection result is received (S 107: Yes), then the cloud server 300 sends the print data to the printer 100 according to the inspection result (S108). The cloud server 300 ends the present process after the step of sending the print data to the printer 100 (S108). Further, it is also possible to elide the step of determining whether or not the cloud server 300 has received an inspection result for the inspection data 90 (S 107), and the step of sending the print data to the printer 100 according to the inspection result (S 108).

<Control of the printer>

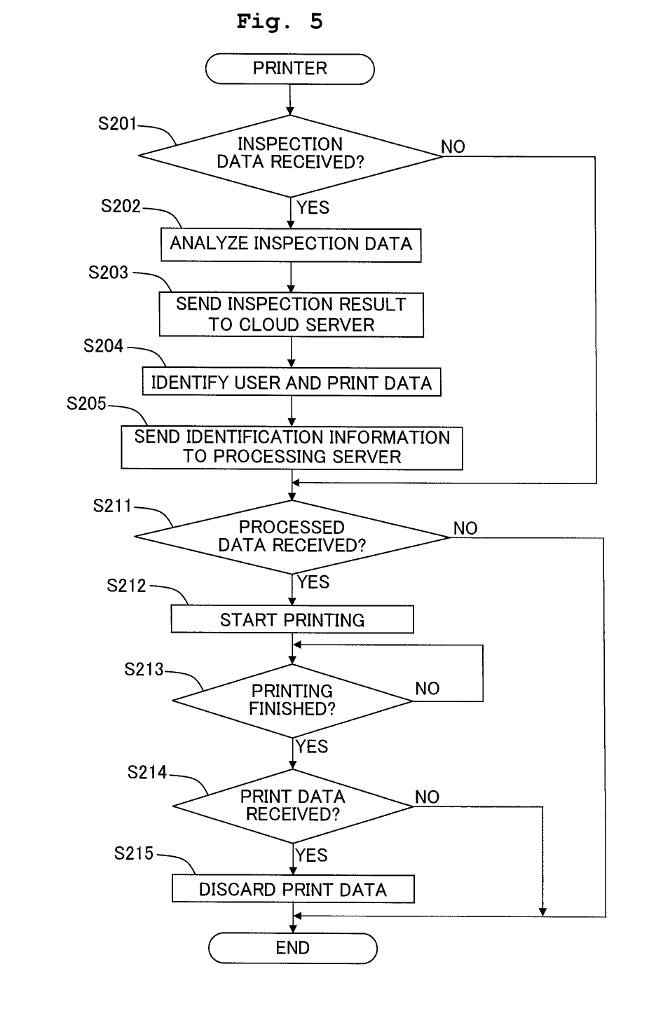

Next, referring to the flowchart of FIG. 5, the operation of the printer 100 will be explained. Further, the printer 100 (the controller 30 of the printer 100, to be exact) periodically (every one second, for example) carries out the process shown in the flowchart of FIG. 5 (an example of the information acquisition section and first transmission section).

The printer 100 first determines whether or not the inspection data 90 is received (S201). When the inspection data 90 is received (S201: Yes), then the printer 100 analyzes whether or not printing is possible for each item of the print setting recorded in the received inspection data 90 (S202). Thereafter, the printer 100 sends the analysis result to the cloud server 300 (S203).

Next, based on the received inspection data 90, the printer 100 identifies the user inputting the print instruction and the print data (S204; an example of the information acquisition section). Then, the printer 100 sends the identification information of recording the identified user and print data to the processing server 400 (S205; an example of the first transmission section). Further, the step of analyzing whether or not printing is possible for each item of the print setting (S202), and the step of sending the analysis result to the cloud server 300 (S203) may as well be carried out after the step of identifying the user and the print data (S204), and the step of sending the identification information to the processing server 400 (S205).

After the step of sending the identification information to the processing server 400 (S205), or when the inspection data 90 is not received (S201: No), then the printer 100 determines whether or not the printer 100 has received from the processing server 400 the processed data which is the print data after the processing treatment (S211). When the processed data is received (S211: Yes), then the printer 100 starts printing for the processed data (S212). Thereafter, the printer 100 determines whether or not the printing for the processed data is finished (S213). When the printing is not finished (S213: No), then the printer 100 waits for the printing to be finished.

When the printing for the processed data is finished (S213: Yes), then the printer 100 determines whether or not the printer 100 has received the print data from the cloud server 300 (S214). When the print data is received (S214: Yes), then the print data is discarded (S215). Note that, the print data mentioned here is that sent to the printer 100 from the cloud server 300 in the aforementioned process (S108). When that process (S108) is not carried out, then the following steps are unnecessary: the step of determining whether or not the printer 100 has received the print data from the cloud server 300 (S214), and the step of discarding the print data in the case of receiving the print data (S215). After the step of discarding the print data (S215), or when the print data is not received (S214: No), or when the processed data is not received (S211: No), then the printer 100 ends the present process.

Further, in the first embodiment, although the printer 100 does not discard the print data sent from the cloud server 300 until the printing for the processed data is finished, the printer 100 may as well discard the print data sent from the cloud server 300 without waiting for the printing for the processed data to be finished. Further, in the case of waiting for the printing for the processed data to be finished, however, even when the printing for the processed data is not successful, it is still possible to carry out a recovery printing by utilizing the print data received later. In this recovery printing, in the same manner as before, the printer 100 sends the print data to the processing server 400, and receives the processed data from the processing server 400 to carry out the printing.

<Control of the processing server>

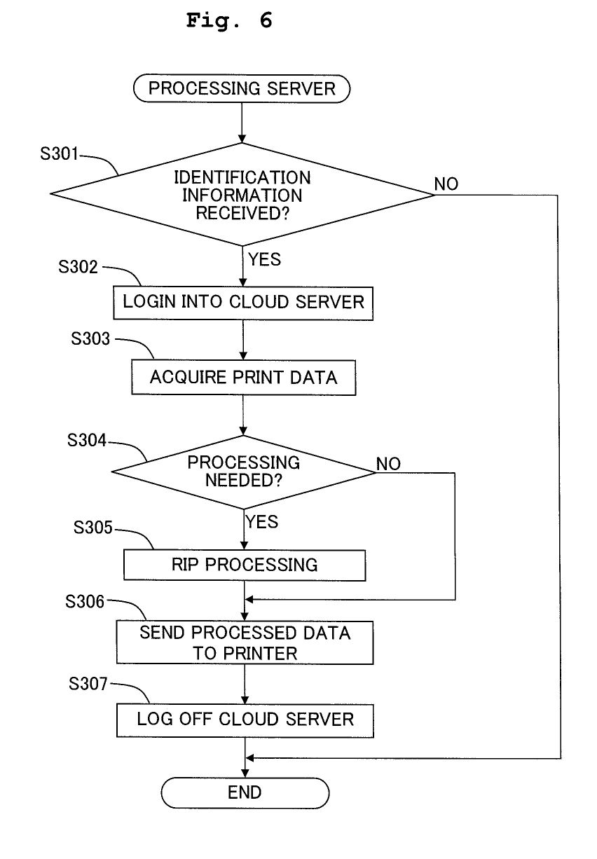

Next, referring to the flowchart of FIG. 6, the operation of the processing server 400 will be explained. Further, the processing server 400 (the controller 50 of the processing server 400, to be exact) periodically (every one second, for example) carries out the process shown in the flowchart of FIG. 6 (an example of the print data acquisition section, processing treatment section, second transmission section, and determination section).

The processing server 400 first determines whether or not the identification information is received (S301). Further, the identification information mentioned here is that sent from the printer 100 in the aforementioned process (S205). When the identification information is not received (S301: No), then the present process is ended.

When the identification information is received (S301: Yes), then the processing server 400 logs into the cloud server 300 on behalf of the user identified by the identification information (S302). Further, the identification information includes the ID and password corresponding to each user for logging into the cloud server 300.

Thereafter, the processing server 400 sends a print data request to the cloud server 300 for requesting to download the print data identified by the identification information, and receives the print data sent from the cloud server 300. In this manner, the processing server 400 acquires the print data without interposing the printer 100 (S303; an example of the print data acquisition section).

Next, the processing server 400 determines whether or not the processing treatment is necessary for the received print data (S304; an example of the determination section). It is possible to determine the necessity of the processing treatment based on, for example, the data type of the print data. In the first embodiment, for instance, the printer 100 has an RIP function compatible with PDL data such as PCL, PostScript and the like, but does not have an RIP function compatible with data in other high-level languages. Therefore, the printer 100 cannot convert any data of non-PDL type into a print command data. Hence, when the data is not of PDL type, then the raster image processing is determined to be necessary. In this case, the processing server 400 previously stores into a database the data types with which the raster image processing is performable by the printer 100. Further, when the data is of bitmap type, then it is possible to determine the raster image processing to be unnecessary.

When the processing treatment is necessary (S304: Yes), then the processing server 400 carries out the raster image processing (S305; an example of the processing treatment section). After this raster image processing, the print data becomes the processed data. When the processing treatment is not necessary (S304: No), then the processing server 400 treats the print data acquired in the previous step (S303) as the processed data without carrying out the raster image processing.

After the raster image processing (S305), or when the processing treatment is not necessary (S304: No), then the processing server 400 sends the processed data to the printer 100 (S306; an example of the second transmission section). Thereafter, the processing server 400 logs off the cloud server 300 (S307), and ends the present process.

As explained in detail hereinabove, in the image forming system 900 of the first embodiment, when the printer 100 is instructed to print for the print data stored in the cloud server 300, then the unprocessed print data stored in the cloud server 300 directly moves to the processing server 400 without passing through the printer 100. Therefore, compared with systems as in the conventional techniques where the print data moves to the processing server 400 through the printer 100, the print data passes through fewer nodes. As a result, it is expectable for the printer 100 to start printing at an early stage.

Especially, by connection with dedicated lines and the like between the cloud server 300 and the processing server 400, it is easier to facilitate speed-up communications therebetween, compared with the communications (with ordinary lines) between the printer 100 and the cloud server 300 or between the printer 100 and the processing server 400. Therefore, the image forming system 900 of the first embodiment is preferentially suitable for reduction of the processing delay arising from the print data passing.

### SECOND EMBODIMENT

<Operational procedure of the image forming system>

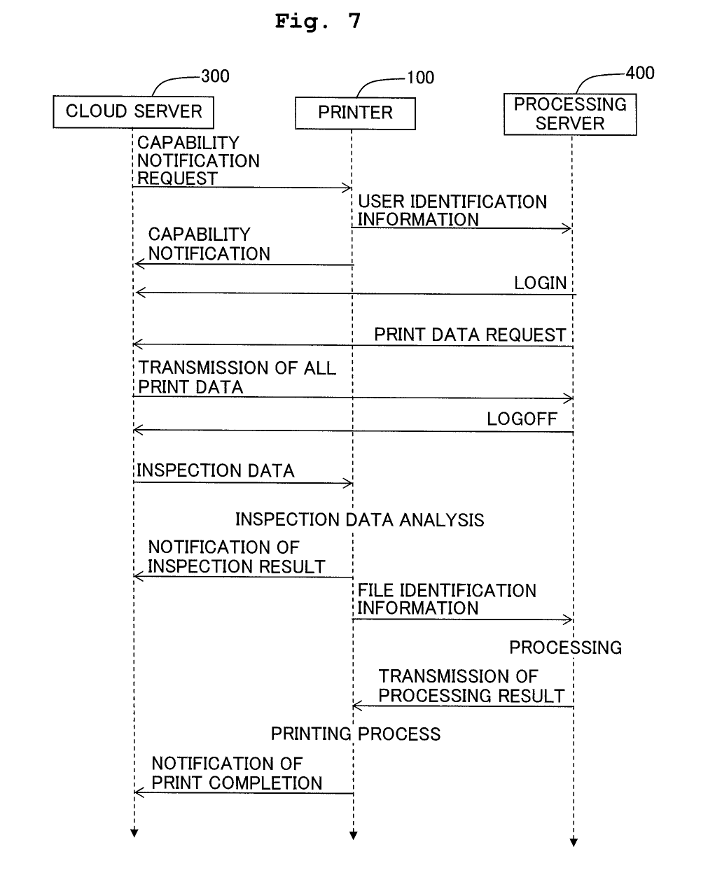

Next, referring to the timing chart of FIG. 7, explanations will be made with respect to an operational procedure of a second embodiment in which at the stage of identifying the user, the printer 100 notifies the processing server 400 of information of the identified user. The processing server 400 downloads all of the print data of the identified user from the cloud server 300, and carries out the processing treatment as necessary. In contrast, in the first embodiment, at the stage of identifying the print data, the printer 100 notifies the processing server 400 of information of the identified print data. Then, the processing server 400 downloads only the identified print data from the cloud server 300, and carries out the processing treatment as necessary. Further, the image forming system of the second embodiment is constituted by the same hardware as that in the first embodiment, any explanations for which will be omitted.

In the image forming system 900 of the second embodiment, first, the user selects a printer for carrying out printing. In the second embodiment, the printer 100 is considered to be selected. As the printer 100 is selected, the cloud server 300 sends a capability notification request to the selected printer 100 for requesting the printer 100 to respond with the printer's capability.

On receiving the capability notification request, the printer 100 notifies the cloud server 300 of its own capability. This capability notification responds with information about at least the specification of the printer 100. The status information (for deciding whether or not it is in a printable state such as shortage of toner, paper out and the like) may as well not be included.

Further, at the stage of receiving the capability notification request, the printer 100 begins the session with the cloud server 300, and is able to acquire the login information. Here, the printer 100 identifies the user from the login information, and sends the user identification information to the processing server 400 for identifying the user.

On receiving the user identification information from the printer 100, the processing server 400 logs into the cloud server 300 on behalf of the identified user. Then, the processing server 400 sends a print data request to the cloud server 300 for sending all of the print data of the identified user. After receiving the print data request, the cloud server 300 sends all of the print data of the identified user to the processing server 400. After receiving the print data, the processing server 400 logs off the cloud server 300.

On the other hand, in the cloud server 300 having received the capability notification, the user selects a print data to be the print target (the print object) from the print data registered in the cloud server 300, and then carries out a print setting. After the user finishes the print setting, a print execution command is inputted to the cloud server 300 according to the print setting.

On accepting the print execution command, the cloud server 300 sends an inspection request according to the print setting to the selected printer (the printer 100 in the second embodiment) before sending the print data.

On receiving the inspection request, the printer 100 analyzes whether or not printing is possible for each item of the print setting of the inspection data 90 added to the inspection request. The printer 100 sends the analysis result to the cloud server 300 as a notification of the inspection result.

Further, on receiving the inspection result, the printer 100 identifies the print data from the information recorded in the inspection data 90, and sends file identification information to the processing server 400 for identifying that print data.

On receiving the file identification information, the processing server 400 finishes the processing treatment for the print data (identified print data) identified by the file identification information from the print data acquired in advance, and sends the processed data after the processing treatment to the printer 100.

The printer 100 accepts the processed data from the processing server 400, and carries out printing for the processed data. After finishing the printing, it sends a printing completion notification to the cloud server 300. Further, the processing server 400 discards the print data acquired but not becoming the objects to send.

<Control of the cloud server>

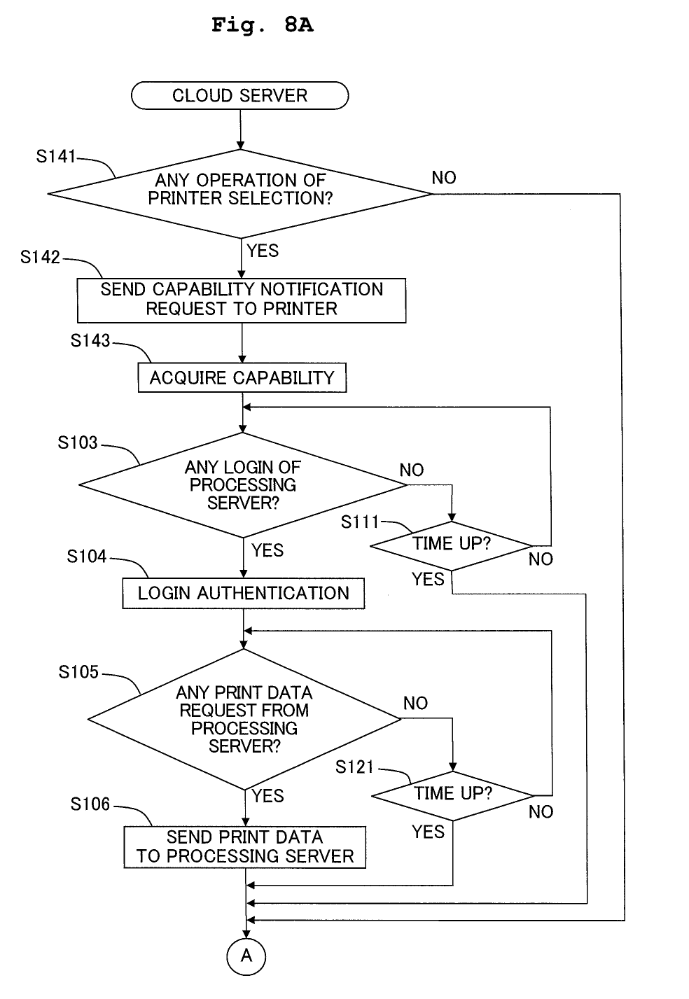

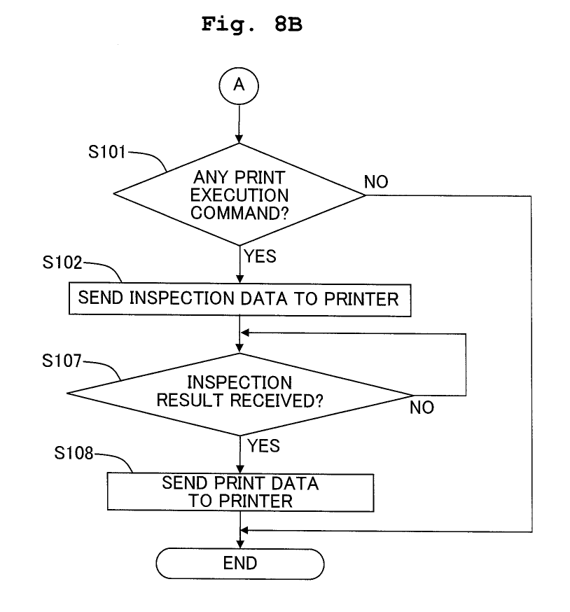

Next, explanations will be made with respect to the operational procedure of each device realizing a printing operation of the image forming system 900 of the second embodiment. At first, referring to the flowchart of FIG. 8, the operation of the cloud server 300 will be explained. Further, the cloud server 300 periodically (every one second, for example) carries out the process shown in the flowchart of FIG. 8. Further, the same steps as in the first embodiment are designated by identical reference numerals, any explanations for which will be omitted.

The cloud server 300 first determines whether or not the user has manipulated to select a printer (S141). When there is no manipulation of printer selection (S141: No), then the process turns to the step of determining whether or not a print execution command is accepted for the print data registered in the cloud server 300 (S101).

When there is a manipulation of printer selection (S141: Yes), then a capability notification request is sent to the selected printer (the printer 100 in the second embodiment) (S142). By this capability notification request, the cloud server 300 begins the session with the printer 100 on the other side. Thereafter, the cloud server 300 acquires information about capability of the printer 100 by receiving a capability notification from the printer 100 (S143).

After the step of receiving the capability notification from the printer 100 (S143), the cloud server 300 determines whether or not the processing server 400 has logged in (S103). When no login is determined (S103: No), then the cloud server 300 determines whether or not the time is up (S111). When the time is up (S111: Yes), then the cloud server 300 lets the process turn to the aforementioned step S 101.

When the processing server 400 has logged in (S103: Yes), then the cloud server 300 carries out an authentication process for the login (S104), and then determines whether or not a print data request is received from the processing server 400 (S105). When there is no print data request (S105: No), then the cloud server 300 determines whether or not the time is up (S121). When the time is up (S121: Yes), then the cloud server 300 lets the process turn to the aforementioned step S101.

When there is a print data request from the processing server 400 (S105: Yes), then the cloud server 300 sends all of the print data requested for transmission to the processing server 400 (S106). Thereafter, the cloud server 300 lets the process turn to the aforementioned step S101.

As described hereinbefore, the cloud server 300 determines whether or not the print execution command is accepted for the print data registered in the cloud server 300 (S101). When the print execution command is not accepted (S101: No), then the cloud server 300 ends the present process.

When the print execution command is accepted (S101: Yes), then the cloud server 300 generates the inspection data 90 according to the print setting, and sends the inspection data 90 to the printer 100 (S102). Thereafter, the cloud server 300 determines whether or not an inspection result is received (S107). When the inspection result is received (S107: Yes), then the cloud server 300 sends the print data to the printer 100 according to the inspection result (S108). After the step of sending the print data to the printer 100 (S108), the present process is ended. Further, the step for the cloud server 300 to determine whether or not an inspection result is received (S107) and the step for the cloud server 300 to send the print data to the printer 100 (S108) may as well be elided.

<Control of the printer>

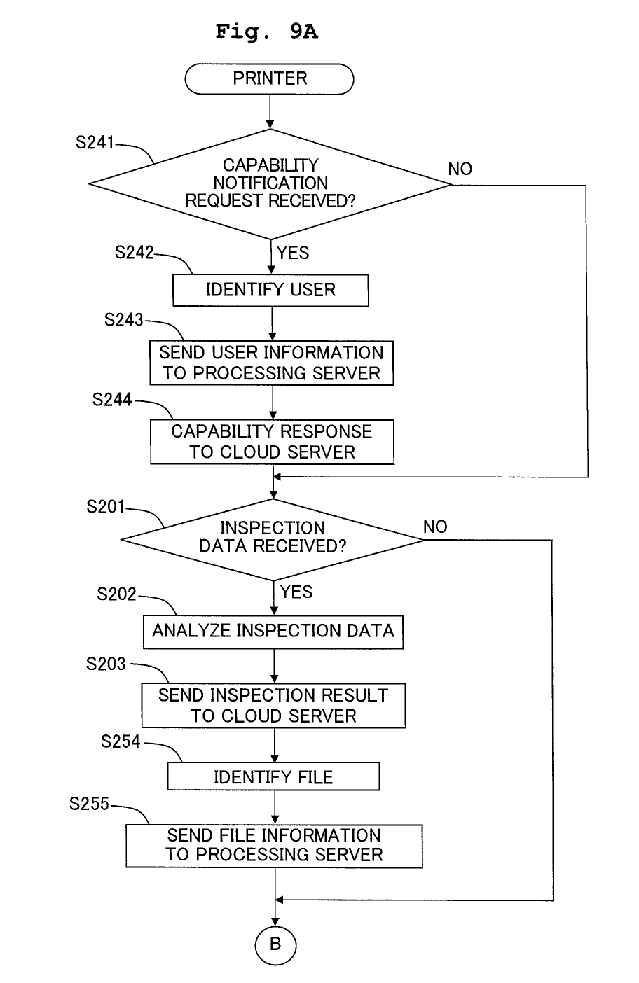

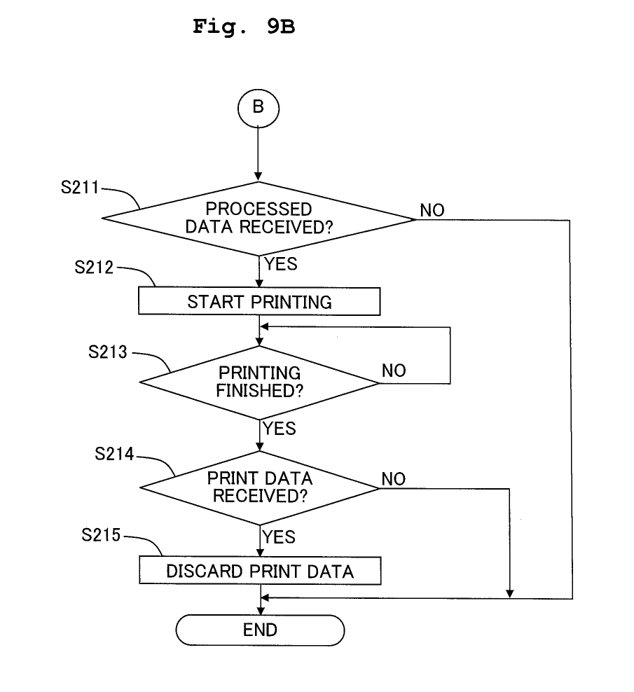

Next, referring to the flowchart of FIG. 9, the operation of the printer 100 will be explained. Further, the printer 100 (the controller 30 of the printer 100, to be exact) periodically (every one second, for example) carries out the process shown in the flowchart of FIG. 9 (an example of the information acquisition section, first transmission section, second information acquisition section, and third transmission section). Further, the same steps as in the first embodiment are designated by identical reference numerals, any explanations for which will be omitted.

The printer 100 first determines whether or not a capability notification request is received (S241). When the capability notification request is received (S241: Yes), then the user is identified (S242; an example of the information acquisition section). When the printer 100 has accepted the capability notification request, the session begins between the printer 100 and the cloud server 300, and thereby it is possible for the printer 100 to identify the user based on the login information at that time. Then, the printer 100 sends the user identification information, which is information about the identified user, to the processing server 400 (S243, an example of the first transmission section). Next, the printer 100 sends a capability notification to the cloud server 300 for notification of its own specification (S244). Further, the step of identifying the user (S242) and the step of sending the user identification information to the processing server 400 (S243) may as well be carried out after the step of sending a capability notification to the cloud server 300 (S244).

After the step of sending the capability notification to the cloud server 300 (S244), or when the capability notification request is not received (S241: No), then the printer 100 determines whether or not the inspection data 90 is received (S201). When the inspection data 90 is received (S201: Yes), then the printer 100 analyzes whether or not printing is possible for each item of the print setting recorded in the received inspection data 90 (S202). Thereafter, the printer 100 sends the analysis result to the cloud server 300 (S203).

Next, based on the received inspection data 90, the printer 100 identifies the print data as the print target (S254; an example of the second information acquisition section). Then, the printer 100 sends the file identification information of recording the identified print data to the processing server 400 (S255; an example of the third transmission section). Further, the step of analyzing whether or not printing is possible for each item of the print setting (S202) and the step of sending the analysis result to the cloud server 300 (S203) may as well be carried out after the step of identifying the print data (S254) and the step of sending the file identification information to the processing server 400 (S255).

After the step of sending the file identification information to the processing server 400 (S255), or when the inspection data 90 is not received (S201: No), then the printer 100 determines whether or not the processed data is received from the processing server 400 (S211). When the processed data is received (S211: Yes), then the printer 100 starts printing for the processed data (S212). Thereafter, the printer 100 waits for the completion of printing for the processed data (S213).

When the printing for the processed data is finished (S213: Yes), then the printer 100 determines whether or not the printer 100 has received the print data from the cloud server 300 (S214). When the print data is received (S214: Yes), then the printer 100 discards the print data (S215). When the cloud server 300 does not carry out the step of sending the print data to the printer 100 (S108), then the following steps are unnecessary: the step of determining whether or not the printer 100 has received the print data from the cloud server 300 (S214), and the step for the printer 100 to discard the print data (S215). After the step for the printer 100 to discard the print data (S215), or when the print data is not received (S214: No), or when the processed data is not received (S211: No), then the printer 100 ends the present process.

<Control of the processing server>

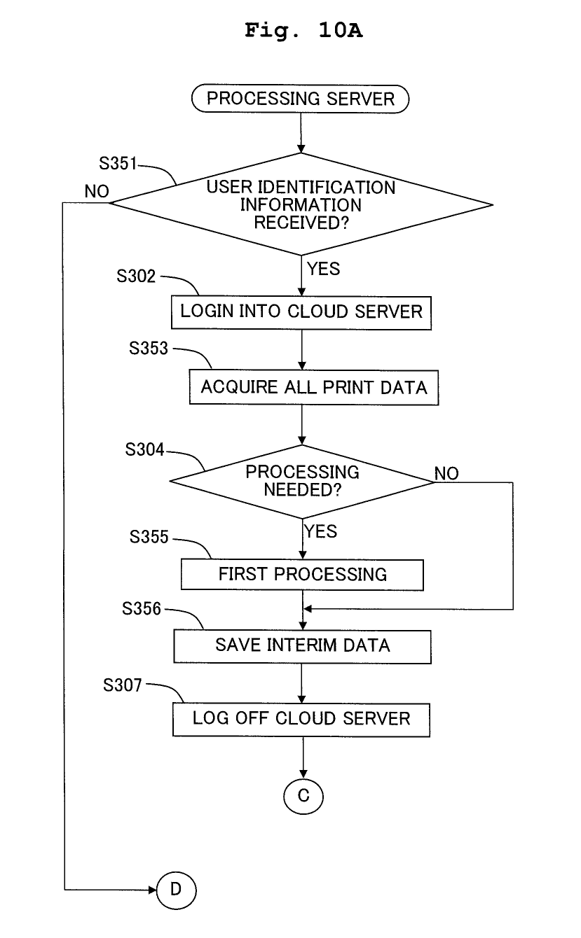

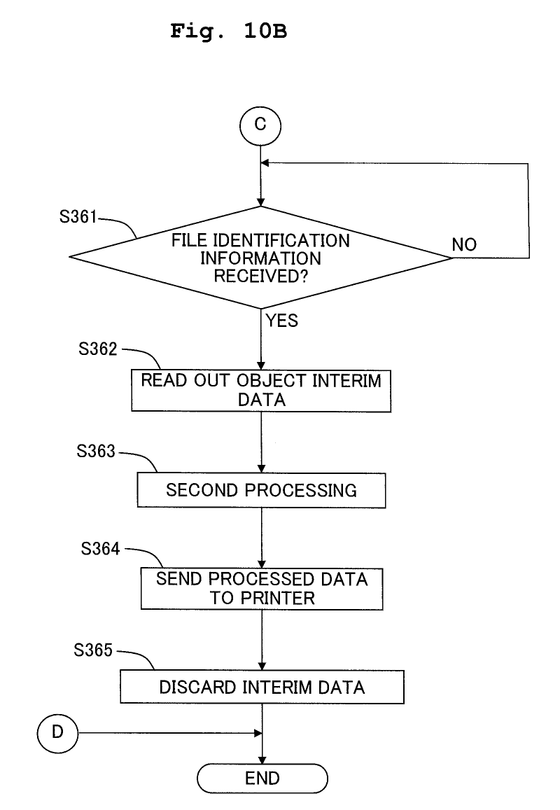

Next, referring to the flowchart of FIG. 10, the operation of the processing server 400 will be explained. Further, the processing server 400 (the control section 50 of the processing server 400, to be exact) periodically (every one second, for example) carries out the process shown in the flowchart of FIG. 10 (an example of the print data acquisition section, processing treatment section, second transmission section, and determination section). Further, the same steps as in the first embodiment are designated by identical reference numerals, any explanations for which will be omitted.

The processing server 400 first determines whether or not the user identification information is received (S351). When the user identification information is received (S351: Yes), then the processing server 400 logs into the cloud server 300 on behalf of the user identified by the user identification information (S302).

Thereafter, the processing server 400 sends a print data request to the cloud server 300 for requesting to send all of the print data of the identified user, and receives all print data sent from the cloud server 300. In this manner, the processing server 400 acquires all of the print data of the identified user without interposing the printer 100 (S353; an example of the print data acquisition section).

Next, the processing server 400 determines whether or not the processing treatment is necessary for each of the received print data (S304; an example of the determination section). When the processing treatment is necessary (S304: Yes), then the processing server 400 carries out a first processing treatment (S355; an example of the processing treatment section). The processing treatment for print data includes a processing treatment for converting vectorial data into pixel data (256 gradations), and a processing treatment for converting pixel data into print command data (2 or 4 gradations). However, the first processing treatment (S355) only coverts vectorial data into pixel data, and thus the print data after the first processing treatment becomes an interim data (temporally data). When the processing treatment is not necessary (S304: No), then the processing server 400 treats the print data acquired in the previous step (S353) as an interim data without carrying out the first processing treatment.

After the first processing treatment (S355), or when the processing treatment is not necessary (S304: No), then the processing server 400 saves the interim data into another memory area of the processing server 400 (S356). Thereafter, the processing server 400 logs off the cloud server 300 (S307).

Thereafter, the processing server 400 determines whether or not the file identification information is received (S361). Further, the file identification information mentioned here is that sent in the aforementioned process (S255). When the file identification information is not received (S361: No), then the processing server 400 waits to receive the file identification information.

When the file identification information is received (S361: Yes), then the processing server 400 reads out the interim data corresponding to the print data identified by the file identification information (S362). Then, the processing server 400 carries out a second processing treatment for the interim data (S363; an example of the processing treatment section). In particular, the second processing treatment (S363) converts pixel data into print command data. The print data after the second processing treatment becomes the processed data.

After the second processing treatment (S363), the processing server 400 sends the processed data to the printer 100 (S364; an example of the second transmission section). Thereafter, the processing server 400 discards the interim data having not become the processing objects in the second processing treatment (S365). After the step of discarding the interim data (S365), the processing server 400 ends the present process.

Further, in the second embodiment, although the processing treatment is divided into the first processing treatment and the second processing treatment, the processing server 400 may as well carry out a full processing treatment including the first processing treatment and the second processing treatment (an equivalent process to the step S305 of the first embodiment) in the same manner as in the first embodiment. For example, after downloading the print data, the processing server 400 may as well carry out the full processing treatment for all print data in the first processing treatment (S355). Alternatively, after receiving the file identification information, that is, after identifying the print data, the processing server 400 may as well carry out the full processing treatment only on the print data in the second processing treatment (S363). However, since the first processing treatment takes time, it is preferable to finish the first processing treatment early.

Further, in the second embodiment, although the printer 100 identifies the user by utilizing the capability notification request outputted from the cloud server 300, the method for identifying the user should not be limited to this method. For example, when the user manipulates the operation panel 40 of the printer 100 to log into the cloud server 300 from the printer 100, then it is possible for the printer 100 to identify the user at the stage of starting the session. Therefore, right after login, the printer 100 may as well send the user identification information to the processing server 400. The timing of identifying the user is often earlier than that of identifying the print data. Therefore, it is possible to provide the processing server with an opportunity to carry out the processing treatment earlier by sending the information of the identified user to the processing server and acquiring the print data of the identified user.

Further, in the second embodiment, although the cloud server 300 notifies the printer 100 of the user information by utilizing the capability notification request outputted on the occasion of selecting a printer, output of the capability notification request should not be limited to this timing. For example, the cloud server 300 may as well utilize the capability notification request outputted on the occasion of accepting a search command or list display command for printers.

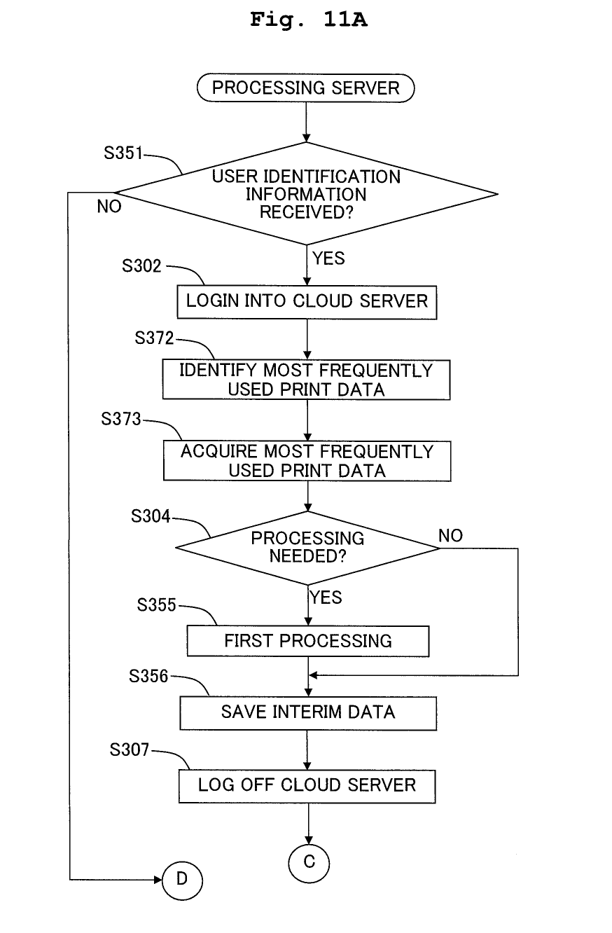

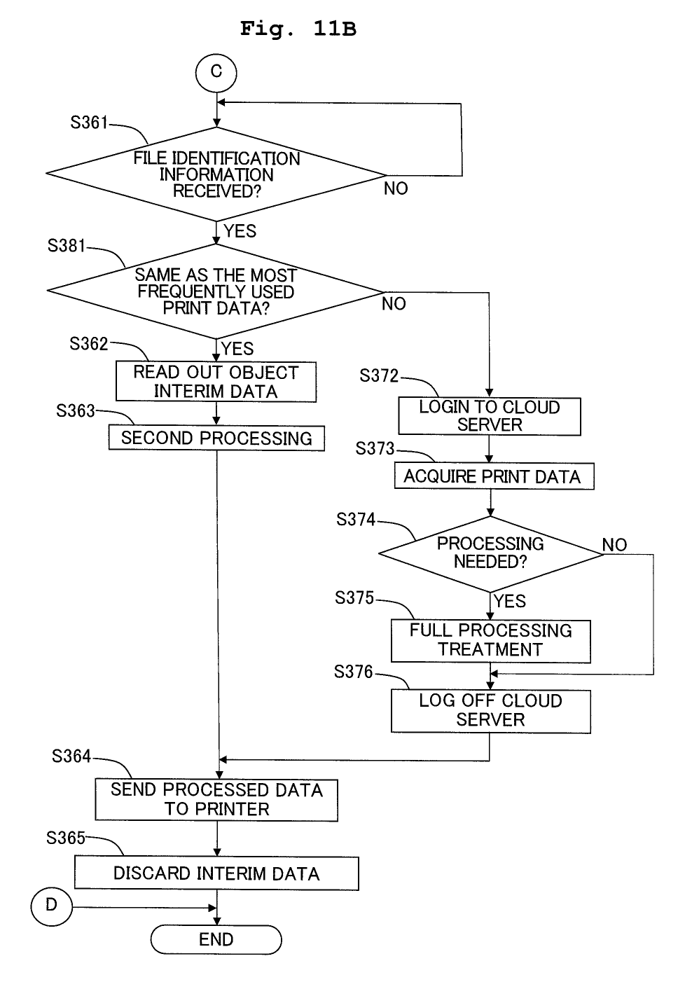

Further, in the second embodiment, although the processing server 400 downloads all of the print data of the identified user, the present teaching should not be limited to this, but may as well download, for example, only the print data satisfying a predetermined condition. FIG. 11 shows a process of the processing server 400 downloading only one print data satisfying the above predetermined condition which prescribes the print data most frequently used.

In FIG. 11, the processing server 400 receives the user identification information (S351: Yes) and, after logging into the cloud server 300 in the step S302, the processing server 400 identifies the most frequently used print data from those of the identified user stored in the cloud server 300 (S372). The cloud server 300 measures the frequency of use by, for example, counting the number of prints performed for each print data, and acquires the print number of each print data. Then, the print data with the largest print number is taken as the most frequently used print data. Further, the print data with the latest file update time may as well be utilized as the most frequently used print data. After the step of identifying the most frequently used print data (S372), the processing server 400 acquires the most frequently used print data from the cloud server 300 (S373). By acquiring the most frequently used print data from the cloud server 300, it is possible for the processing server 400 to reduce the number of the print data to be received. Further, since the most frequently used print data has a high possibility to become a print target, it is preferably taken as a print data for the processing server 400 to acquire in advance.

Thereafter, when the file identification information is received (S361: Yes), then the processing server 400 determines whether or not the print data recorded in the file identification information is the same as the most frequently used print data (S381). When they are the same (S381: Yes), then the processing server 400 reads out the interim data (S362), and carries out the second processing treatment (S363).

When they are different (S381: No), then the processing server 400 logs into the cloud server 300 again (S372), and acquires the print data identified by the file identification information (S373; an example of the second print data acquisition section). Thereafter, the processing server 400 determines whether or not a processing treatment is necessary for the received print data (S374). When the processing treatment is necessary (S374: Yes), then the processing server 400 carries out the full processing treatment for the print data (S375; an example of the second processing treatment). The print data after this full processing treatment becomes the processed data. When the processing treatment is not necessary (S374: No), then the processing server 400 does not carry out the full processing treatment, but treats the print data acquired in the step of acquiring the print data identified by the file identification information as the processed data (S373).

After the full processing treatment (S375), or when the processing treatment is not necessary (S374: No), then the processing server 400 logs off the cloud server 300 (S376), and lets the process turn to the step 5364 to send the processed data to the printer 100. In this manner, it is possible to reduce the load on the resource of the processing server 400 by restricting the number of the print data downloaded by the processing server 400 from the cloud server 300. Further, it is possible to reduce the load on the processing server 400 by lessening the number of executions of the processing treatment. On the other hand, since the processing server 400 downloads all print data, the processing server 400 does not need to log in and log off over again as in the aforementioned steps 5372 to 5376, thereby simplifying the process.

Further, in FIG. 11, the processing server 400 downloads only the most frequently used print data at first. When it is different from the identified print data recorded in the file identification information, then the processing server 400 downloads the identified print data. However, the present teaching should not be limited to this scheme. For example, the processing server 400 may as well download all print data of the identified user at first and process only the most frequently used print data for the meantime. When the most frequently used print data is different from the identified print data recorded in the file identification information, then the processing server 400 begins to process the identified print data.

As explained in detail hereinabove, in the image forming system 900 of the second embodiment, when a printer is selected to carry out printing after the user logs into the cloud server 300, then the unprocessed print data of the user stored in the cloud server 300 directly moves to the processing server 400 without passing through the printer 100. Therefore, compared with systems as in the conventional techniques where the print data moves to the processing server 400 through the printer 100, the print data passes through fewer nodes. As a result, it is expectable for the printer 100 to start printing at an early stage.

Further, the above embodiments are merely exemplifications, and thus by no means limit the present teaching. Therefore, as a matter of course, it is possible to apply various modifications and changes to the present teaching without departing from the true spirit and scope thereof. For example, it is possible to let multifunction printing apparatuses or copying machines play the role of the printer as long as they are provided with a printing function. Further, the device for inputting the print job to the printer should not be limited to a mobile terminal such as smartphones and the like but may as well be an information processing device such as desktop PCs, notebook PCs and the like.

Further, in the above embodiments, although the print job is sent from the smartphone 200 to the printer 100 via the cloud server 300, it should not be limited to this transmission route but may as well be sent, for example, directly from the smartphone 200 to the printer 100. In this case, the smartphone 200 sends to the processing server 400 the inspection request and the print data, which are otherwise sent by the cloud server 300.

Further, in the above embodiments, the processing server 400, which is an external device, carries out the raster image processing. However, the processing treatment carried out by an external device should not be limited to the raster image processing but may as well be, for example, watermark processing or translucent processing. Further, it may also be a process of converting a PDL data into another PDL data such as from PCL to PostScript, and the like.

What is claimed is:

1. An image forming system which forms an image on a medium, the system comprising:
a data server which stores print data;
an image forming apparatus which carries out printing for the print data; and
a processing server which carries out a processing treatment for the print data,
wherein the image forming apparatus comprises an information acquisition section which is configured to acquire identification information including information for identifying a print target, and a first transmission section which is configured to transmit the identification information to the processing server under a condition that the information acquisition section has acquired the identification information; and
the processing server comprises a print data acquisition section which is configured to acquire an identified print data identified through the identification information among the print data stored in the data server in the case of receiving the identification information from the image forming apparatus, a processing treatment section which is configured to carry out the processing treatment for the identified print data acquired by the print data acquisition section, and a second transmission section which is configured to transmit, to the image forming apparatus, a processed data which is the identified print data that has been processed by the processing treatment section.

2. The image forming system according to claim 1, wherein the identification information acquired by the information acquisition section is information for identifying each of the print data, and the print data acquisition section acquires an identified print data identified through the identification information from the data server.

3. The image forming system according to claim 1, wherein the identification information acquired by the information acquisition section is information for identifying a user;
the image forming apparatus further comprises a second information acquisition section which is configured to acquire second identification information including information for identifying print data of the print target, and a third transmission section which is configured to transmit the second identification information to the processing server under a condition that the second information acquisition section has acquired the second identification information;
the print data acquisition section is configured to acquire at least one of the print data of the user identified through the identification information; and
the second transmission section is configured to transmit to the image forming apparatus an identified print data which is the processed data identified through the second identification information among the print data acquired by the print data acquisition section after acquiring the second identification information from the image forming apparatus.

4. The image forming system according to claim 3, wherein the print data acquisition section is configured to acquire all print data of the user identified through the identification information; and
the processing treatment section is configured to carry out a first processing treatment in which the print data acquired by the print data acquisition section is processed to form interim data from print data before acquiring the second identification information, and the processing treatment section is configured to carry out a second processing treatment in which the identified print data identified through the second identification information is processed to form, from the interim data, the processed data among the print data acquired by the print data acquisition section after acquiring the first identification information.

5. The image forming system according to claim 3, wherein the print data acquisition section acquires the most frequently used print data from the print data of the identified user; and
the processing server further comprises a second print data acquisition section which is configured to acquire the identified print data identified through the second identification information from the data server under a condition that the most frequently used print data acquired by the print data acquisition section differs from the identified print data identified through the second identification information, and a second processing treatment section configured to carry out processing treatment for the identified print data acquired by the second print data acquisition section.

6. The image forming system according to claim 3, wherein the processing treatment section is configured to start the processing treatment for the print data immediately after the print data acquisition section acquires the print data.

7. The image forming system according to claim 1, wherein the processing server further comprises a determination section which is configured to determine whether or not it is necessary for the processing treatment section to carry out the processing treatment for the print data acquired by the print data acquisition section; and
the processing treatment section is configured to carry out the processing treatment for the print data for which the determination section determines the processing treatment to be necessary, but not to carry out at least part of the processing treatment for the print data for which the determination section determines the processing treatment to be unnecessary.

8. The image forming system according to claim 1, wherein the print data includes a print data of a first format and a print data of a second format;
the image forming apparatus has a processing treatment section which is configured to carry out a processing treatment for the print data of the first format but not to carry out the processing treatment for the print data of the second format; and
the processing treatment section of the processing server is configured to carry out the processing treatment for the print data of the second format for which the processing treatment section of the image forming apparatus is incapable of the processing treatment.

9. An image forming apparatus which forms an image on a medium, the apparatus being connected through communication channels with a data server which stores print data, and a processing server which carries out a processing treatment for the print data, the apparatus comprising:
an information acquisition section configured to acquire identification information including information for identifying a print target;
an acquisition instruction section configured to transmit the identification information to the processing server under a condition that the information acquisition section has acquired the identification information, and the acquisition instruction section is configured to cause the processing server to acquire an identified print data which is the print data identified through the identification information among the print data stored in the data server; and
a printing section configured to receive a processed data which is the identified print data to which the processing treatment has been applied by the processing server, and to carry out printing for the processed data.

10. A processing server which processes print data, the server being connected through communication channels with a data server for storing the print data, and an image forming apparatus which carries out printing for the print data on a medium, the server comprising:
a receiving section which receives identification information including information for identifying a print target from the image forming apparatus;
a print data acquisition section configured to acquire an identified print data which is the print data identified through the identification information among the print data stored in the data server under a condition that the receiving section has received the identification information;
a processing treatment section configured to carry out a processing treatment for the identified print data acquired by the print data acquisition section; and
a transmission section configured to transmit, to the image forming apparatus, a processed data which is the identified print data that has been processed by the processing treatment section.

11. The processing server according to claim 10, wherein the print data includes a print data of a first format and a print data of a second format;
the image forming apparatus has a processing treatment section configured to carry out a processing treatment for the print data of the first format but not to carry out the processing treatment for the print data of the second format; and
the processing treatment section of the processing server is configured to carry out the processing treatment for the print data of the second format for which the processing treatment section of the image forming apparatus is incapable of the processing treatment.
